(19) United States
(12) Patent Application Publication
(10) Pub. No.: US 2011/0108065 A1
(43) Pub. Date: May 12, 2011

(54) RINSING METHOD FOR A WATER-CONVEYING DOMESTIC APPLIANCE

(75) Inventors: Helmut Jerg, Giengen (DE); Michael Georg Rosenbauer, Reimlingen (DE)

(73) Assignee: BSH BOSCH UND SIEMENS HAUSGERÄTE GMBH, Munich (DE)

(21) Appl. No.: 13/003,766

(22) PCT Filed: Jul. 15, 2009
(86) PCT No.: PCT/EP2009/059019

§ 371 Date: Jan. 12, 2011

(30) Foreign Application Priority Data
Jul. 23, 2008 (DE) 10 2008 040 650.3

(51) Int. Cl. B08B 7/04

(52) U.S. Cl. 134/18

(57) ABSTRACT

A washing method for a water-conveying domestic appliance is provided. In at least one sub-program step of a first washing operation in a first operating mode, washing liquid is warmed up to a first temperature. After a number of washing operations that are carried out in the first operating mode and/or as a function of process parameters of preceding washing operations, at least one washing operation is carried out in a second operating mode, during which the washing liquid is warmed up to a second temperature. The second temperature is higher than the first temperature.

The invention relates to a washing method for a water-conveying domestic appliance, in particular a dishwasher, in accordance with the characterizing clause of claim 1.

A washing method for a dishwasher is known, from DE 10 2005 004 089 A1, in which a quantity of washing liquid provided in a washing compartment is, in a cleaning step, heated to a cleaning temperature during a heating up phase. As the drying device, a sorption column is provided containing reversibly dehydratable material which, in a drying step, extracts from the air to be dried a quantity of water, and stores this. Then, in a subsequent washing operation during the cleaning step a regeneration operation or desorption, as applicable, takes place, in which a flow of air, which is sucked out from the washing compartment and flows through the desiccant, is heated by means of heating of the air. The flow of heated air releases as hot water vapor the quantity of water stored in the desiccant, and this is fed back into the washing compartment.

However, with this method a formation of deposits can occur, in particular in the hydraulic system of the water-conveying domestic appliance.

The object of the invention consists in providing a washing method for a water-conveying domestic appliance, in particular for a dishwasher, to prevent unwanted deposit formation.

This object is achieved by the characteristics of claim 1. Advantageous developments of the invention are disclosed in the sub-claims.

The starting point for the invention is a washing method for a water-conveying domestic appliance, in particular for a dishwasher, which has, in particular, a drying device which has a reversibly dehydratable desiccant, in which in at least one sub-program step of a first washing operation washing liquid is warmed to a first temperature in a first mode of operation. Here, a washing operation can incorporate a plurality of sub-program steps, such as for example pre-wash, clean, preliminary rinse, final rinse and dry, which are executed one after another for the purpose of cleaning items to be washed.

In accordance with the invention, provision is made that after a prescribed number of washing operations carried out in the first mode of operation, and/or as a function of process parameters of preceding washing operations, at least one washing operation is carried out in a second mode of operation, during which washing liquid is warmed up to a second temperature, which is higher by, comparison with the first temperature.

As a result of the raised temperature in the second mode of operation, the deposit which is forming in the piping system of the hydraulic circuit undergoes an accelerated loosening, so that there is no danger of the flow of the washing liquid, which is being circulated in the hydraulic circuit, being impeded due to a build up of deposits. Here, in accordance with the invention, after a prescribed number of washing operations carried out in the first mode of operation, at least one washing operation is carried out in the second mode of operation.

In this way, it is possible in accordance with the invention to forgo any direct detection of the build up of a deposit in the hydraulic system, which would require expensive measurement technology. Accordingly, the use of deposit sensors for the purpose of monitoring the deposit can be forgone.

The dishwasher can then, in the normal situation, carry out washing operations which work with a normal temperature profile. After a prescribed number of such washing operations, at least one washing operation, which works with a high temperature profile, can be interposed. A change between the first and second modes of operation, structured in this way, is based on investigations which have shown that deposit formation in the dishwasher's hydraulic system does not take place within one washing operation, or a few, but only in the case of continuous operation in the low temperature region. Hence it is possible to work with a high-temperature profile/low-temperature profile in a mathematical sequence.

Alternatively and/or additionally, it is also possible to switch from the first to the second mode of operation as a function of process parameters for preceding washing operations. Process parameters of this sort which could be considered are, in particular, the temperature profiles of the preceding washing operations which, depending on the maximum temperatures reached during them, have a large influence on the formation of deposits. In general, however, the process parameters which could be monitored are all those variables which influence the formation of deposits in the hydraulic system. Examples of such parameters could be, apart from the temperature profile, the amount of washing liquid circulated or the degree of soiling of the items to be washed.

In the second mode of operation, the temperature is raised in such a way, in particular, that fat deposits and/or soiling in the dishwasher's hydraulic system can be reliably loosened. In particular, the second temperature in the second mode of operation should be in the order of magnitude of 60° C. to 65° C.

The invention can be used in particular with dishwashers with a separate drying system, where the air to be dried is sucked out of the washing compartment during the drying step and is fed through a desiccant which extracts the moisture from the air, wherein the air thus dried is fed back again into the washing compartment, in a closed circuit.

In the case of such a drying operation, heating of the washing liquid up to a temperature of the order of magnitude of 65° C., in the “final rinse” sub-program step which precedes the drying step, is omitted. Such heating up is necessary in order to permit effective condensation on the washing compartment sidewalls in a subsequent drying step. In contrast to this, in accordance with the invention the moisture-laden air warms up during the external drying operation, due to the inherent warmth of the dishes which are being washed, only to about 30° C. Heating up to temperatures of 65° C. to 75° C. during the final rinse step is here unnecessary.

An exemplary embodiment of the invention is described below by reference to the attached figures. These show:

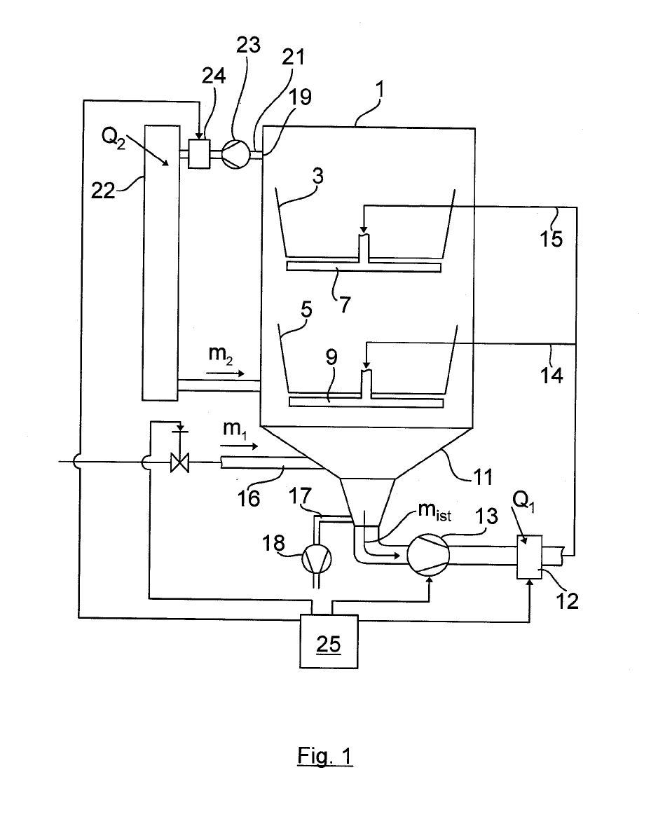

FIG. 1 a schematic block diagram of a dishwasher for carrying out the washing method; and

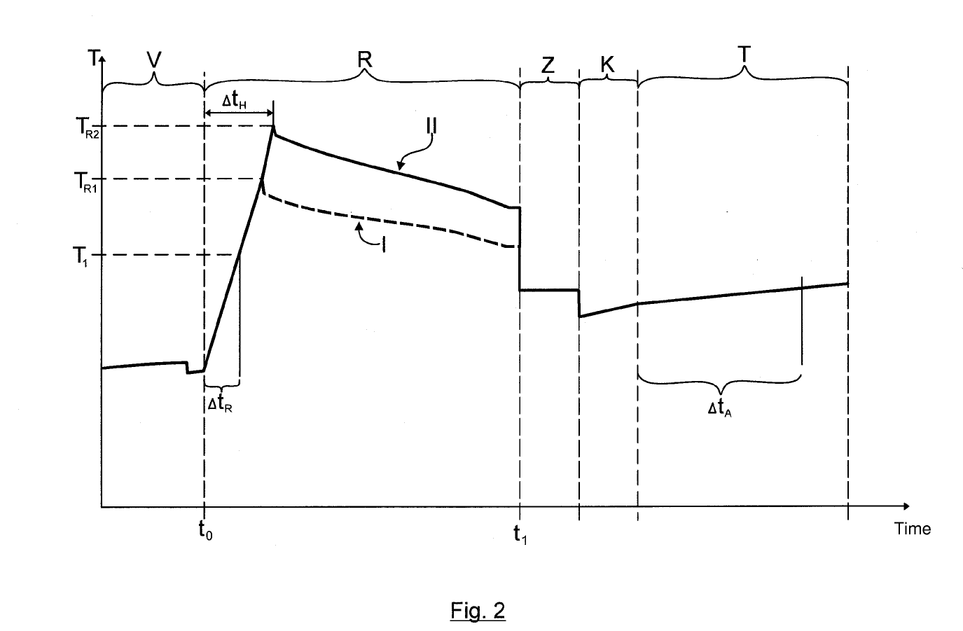

FIG. 2 a temperature-time diagram to illustrate the execution of a washing program in a first, washing mode and in a second washing mode.

FIG. 1 shows, as an exemplary embodiment of a water-conveying domestic appliance, the schematic outline of a dishwasher with a washing compartment 1, in which can be arranged items to be cleaned, which are not shown, in crockery baskets 3, 5. Arranged in the washing compartment 1 shown there are, as examples of spray devices, two spray arms 7, 9 in different spray planes, through which washing fluid is applied to the items to be cleaned. Provided in the base of the washing compartment is a pump chamber 11 with a circulating pump 13 which has a liquid-flow connection to the spray arms 7, 9 via feed lines 14, 15. Connected downstream from the circulation pump 13 is a heating element 12, such as a through-flow heater, which is also referred to as a water heater. Apart from this, the pump chamber 11 is connected via spigots to a clean water supply pipe 16, connected to the water mains, and to a discharge pipe 17 in which is arranged a drain pump 18 for pumping away the washing liquid out of the washing compartment 1.

In its upper region, the washing compartment 1 has an outlet opening 19 which is connected via a pipe 21 to a drying device in the form of a sorption column 22. An air blower 23 together with a heating element 24 are inserted in the pipe 21 to the sorption column 22. As the desiccant, the sorption column 22 contains a reversibly dehydratable material, such as zeolite, by which air is dried in a drying step T. To this end, a flow of air heavily laden with moisture is fed from the washing interior bounded by the washing compartment through the sorption column 22, by means of the air blower 23. The zeolite provided in the sorption column 22 takes up the moisture from the air and the air thus dried is fed back again into the washing interior of the washing compartment 1.

The quantity of water m₂ stored in the zeolite in the drying step T can be released again in a regeneration operation, i.e. a desorption, by heating up the desiccant in the sorption column 22. To this end, the blower 23 is used to pass through the sorption column 22 a flow of air, heated to high temperatures by the heating element 24, with which the water stored in the zeolite is released as hot water vapor and thus fed back again into the washing compartment 1. The regeneration operation in the sorption column 22, described above, takes place in the time interval Δt_{R} in the temperature-time profile shown in FIG. 2.

FIG. 2 illustrates a program timing sequence with the individual sub-program steps of a washing operation, namely pre-wash V, clean R, preliminary rinse Z, final rinse K and dry T. The sub-program steps indicated in FIG. 2 are executed by means of a controller 25, by appropriate actuation of the water heater 12, the circulation pump 13, the drain pump 18, the air blower 23, the drying device 22 and other control components.

The diagram in FIG. 2 shows the temperature profile over time, both for a first mode of operation I and also for a second mode of operation II. The temperature profiles for the two modes of operation are identical to each other except for the different temperature paths in the cleaning step R. In FIG. 2, the temperature path for the first mode of operation I during the cleaning step R is shown as a dashed line.

The heat Q₂ released during the regeneration operation Δt_{R} is used, for energy-saving, to heat up the washing liquid mᵢₛₜ during the heating-up phase Δt_{H} of the cleaning step R. Thus, as shown in FIG. 2, the regeneration operation Δt_{R} starts at the start of the cleaning step R, at the point in time t₀, after the pre-wash step V has been carried out. In the regeneration operation Δt_{R}, the quantity of water m₂ stored in the desiccant is fed back as water vapor into the washing compartment 1. This quantity of water was extracted, during an adsorption operation Δt_{A}, from a moisture-laden airflow which was to be dried in the drying step T of a preceding washing operation. The total quantity of washing liquid mᵢₛₜ provided in the cleaning step R is thus given by a quantity of clean water m₁ fed into the washing compartment via the clean water pipe 16 and the quantity of water m₂ fed back into the washing compartment in the regeneration operation Δt_{R}.

At the start of the cleaning step R, the washing liquid, which is circulated in the dishwasher's liquid circuit by means of the circulation pump 13, is warmed up to a cleaning temperature in the known way in a heating up phase Δt_{H}. The regeneration operation Δt_{R}, which is performed with parallel timing with the heating-up phase Δt_{H}, assists the warming of the washing liquid. So, during the heating-up phase not only is a first heating capacity Q₁ injected into the washing compartment 1 by means of the first heating element 23, i.e. the water heater, indicated in FIG. 1. In addition, in the regeneration operation a second heating capacity Q₂ is also injected into the washing compartment 1 by means of the second heating element 24, i.e. the air heater. The heating capacity Q₁ from the water heater 23 can be around 2,200 W, while the heating capacity Q₂ from the air heater 24 is only of the order of magnitude of 1,400 W.

In the heating-up phase Δt_{H}, the warming of the washing liquid is effected initially only by means of the water vapor released in the regeneration mode Δt_{R}, which can warm up the washing liquid with the heating capacity Q₂ to a temperature T₁ of here by way of example, about 40° C. Only after the regeneration operation has ended is the water heater 12 switched in, working with its significantly greater heating capacity Q₁. By only switching in the water heater 12 after the end of the regeneration operation Δt_{R}, any thermal damage to the desiccant in the sorption column 22 can be avoided.

By means of the water heater 12, which is only switched in after the regeneration operation Δt_{R}, the temperature of the washing liquid is raised in the first mode of operation I from a temperature T₁ of 40° C. to a cleaning temperature T_{R1} which is sufficiently high for cleaning purposes. The cleaning temperature T_{R1} can here, by way of example, be 51° C.

After the heating-up phase Δt_{H}, the temperature of the washing liquid and of the items to be washed falls off roughly linearly until the washing liquid is diverted into the waste water system at the end of the cleaning step R, at the point in time t₁. The sub-program steps “preliminary rinse Z” and “final rinse K”, which follow the cleaning step R, work at even further reduced washing liquid temperatures.

After the final rinse K, the drying step T follows. Unlike a conventional drying operation, in which the drying of the moisture-laden air is effected by condensation on the sidewalls of the washing compartment, reheating of the washing liquid up to temperatures of between 60° C. and 70° C. in the preceding final rinse step K can here be forgone. Instead, the drying step T takes place as shown in the diagram in FIG. 2, at a temperature of about 30° C., which arises as a result of the inherent warmth of the items to be washed.

However, the path of the temperature in the first mode of operation I is accompanied by the disadvantage that during the washing operation no appropriately high-temperature washing liquid circulates in the hydraulic system to prevent the formation of deposits by fat precipitation or other pollutants. The cleaning temperature T_{R1} in the first mode of operation I, of the order of magnitude of 50° C., is indeed adequate for a good cleaning result, but is not however suitable to break down fats and eliminate them from the hydraulic system.

In accordance with the invention, therefore, the controller 25 can switch from the first mode of operation I to the second mode of operation II, in which the cleaning temperature is raised as shown in FIG. 2 to T_{R2}. In the second mode of operation II the cleaning temperature T_{R2} amounts to about 60° C. to 65° C. by which the formation of deposits can be reliably prevented.

With regard to reducing the energy consumption of the dishwasher, the controller 25 can carry out a washing operation in the second mode of operation II, with an appropriately raised temperature T_{R2}, only after a prescribed number of washing operations carried out in the first mode of operation I. In the case of a particularly suitable alternation of modes, three washing operations can for example be carried out with a high temperature profile with the raised cleaning temperature. T_{R2}, while the two subsequent washing operations can be carried out with a low temperature profile, with the reduced cleaning temperature T_{R1}.

As an alternative to such an alters cation of modes being laid down in the controller 25, a deposit sensor can be provided, with a signaling connection to the controller 25. The deposit sensor and the controller 25 can be linked into a closed control loop, by which the second mode of operation is selected only when a prescribed level of pollution is reached. Correspondingly, the energy consumption of the dishwasher can be reduced as an arithmetic mean, that is to say over a series of washing operations which are carried out.

### LIST OF REFERENCE MARKS

1 Washing compartment
3 Crockery basket
5 Crockery basket
7 Spray arm
9 Spray arm
11 Pump chamber
12 Heating element
13 Circulation pump
14 Feed pipe
15 Feed pipe
16 Clean water feed pipe
17 Discharge pipe
18 Drain pump
19 Outlet opening
21 Pipe
22 Drying device
23 Air blower
24 Heating element
25 Controller
29 Temperature sensor
V Pre-wash
R Clean
Z Preliminary rinse
K Final rinse
T Dry
T_{R1} Cleaning temperature
T_{R2} Cleaning temperature
Δt_{R} Regeneration operation
Δt_{H} Heating-up phase
t₀ Time point for start of the cleaning step R
t₁ Time point for end of the cleaning step R
m₁ Amount of clean water fed in
m₂ Quantity of water fed back in the regeneration operation
mᵢₛₜ Quantity of washing liquid
Q₁ Heating capacity
Q₂ Heating capacities
Δt_{A} Adsorption operation
I First mode of operation
II Second mode of operation

1-11. (canceled)

12. A washing method for a water-conveying domestic appliance, the method comprising:
warming up washing liquid to a first temperature in at least one sub-program step of a first washing operation in a first operating mode; and
at least one of after a predetermined number of washing operations carried out in the first operating mode and as a function of process parameters of preceding washing operations, carrying out at least one washing operation in a second operating mode, during which the washing liquid is warmed up to a second temperature that is higher than the first temperature.

13. The washing method of claim 12, wherein the water-conveying, domestic appliance is a dishwasher that has a drying device with a reversibly dehydratable desiccant.

14. The washing method of claim 12, further comprising monitoring the process parameters, wherein the process parameters are at least one of a temperature profile and other influencing variables that influence formation of deposits in a hydraulic system of the water-conveying domestic appliance.

15. The washing method of claim 12, wherein the at least one sub-program step, which is carried out in one of the first and second operating modes, is a cleaning step in which the first and second temperatures respectively correspond to a cleaning temperature.

16. The washing method of claim 14, wherein the second temperature of the at least one sub-program step carried out in the second operating mode is raised to such a level that at least one of grease deposits and pollutants in the hydraulic system of the dishwasher are loosened.

17. The washing method of claim 16, wherein the second temperature is raised to an order of magnitude of 60° C. to 65° C.

18. The washing method of claim 14, wherein respective temperatures of sub-program steps that are carried out before or after the cleaning step are less than the respective first and second temperatures.

19. The washing method of claim 18, wherein the sub-program steps include a pre-wash step, a preliminary rinse step, a final rinse step and a drying step.

20. The washing method of claim 19, wherein, in the drying step, air in a washing compartment is fed through a drying device with a reversibly dehydratable desiccant.

21. The washing method of claim 20, wherein the air from the drying device is fed back into the washing compartment.

22. The washing method of claim 20, wherein, in a regeneration operation, a quantity of water stored in the desiccant is fed back into the washing compartment as heated water vapor which, in the cleaning step, warms up the washing liquid to a predetermined temperature.

23. The washing method of claim 22, wherein the washing liquid that has been heated to the predetermined temperature is further warmed up to one of the first and second temperatures by a water heater provided in a washing liquid circuit.

24. The washing method of claim 12, wherein the first temperature in the first operating mode is of the order of magnitude of 45° C. to 55° C., and wherein the second temperature in the second operating mode lies in a range of 60° C. to 65° C.
